(19) United States
(12) Patent Application Publication
(10) Pub. No.: US 2010/0026029 A1
(43) Pub. Date: Feb. 4, 2010

(54) Storage Compartment for Truck Tractor Lines

(76) Inventor: John M. Easling, Ogden, UT (US)

Correspondence Address: Thompson E. Fehr;Goldenwest Corporate Center, Suite 300, 5025 Adams Avenue, Ogden, UT, 84403, US

(21) Appl. No.: 12/168,792

(22) Filed: Jul. 7, 2008

(51) Int. Cl. B60R 11/00

(52) U.S. Cl. 296/37.6

(57) ABSTRACT

A storage compartment for truck tractor lines closed, when installed, on all sides except for that portion of a shelf necessary to admit and hold the glad hands and power plug. An optional lower cover can close the entire container when no glad hand or power plug is present. Access is through a rear door which can preferably be placed and remain in either an open or a closed position. Optionally, at least one projection is attached to the front of the container to hold extra rubber grommets for the glad hand; and at least one spring is similarly attached for releasably retaining a flashlight, pressure gauge, or other items of use to a truck driver, such as an air line repair kit.

### BACKGROUND OF THE INVENTION

1. Field of the Invention

This invention relates to containers for storing air hose couplings (or connectors) and electric cable plugs of the type used on the tractors and trailers of semi-trailer trucks when the couplings and plugs are not being utilized. Such couplings or connectors are traditionally called “glad hands.”

2. Description of the Related Art

Semi-trailer trucks possess one or more trailers and a powered unit within which the driver sits and which is called a tractor.

A flexible electrical line has a free end for connecting the electrical system contained within the tractor to the trailer or for making electrical connections for the electrical system from one trailer to another, for operating devices requiring electrical power, such as lights and refrigeration systems. Attached to the free end of the electrical line is a power plug, which is utilized to establish a removable connection to supply electricity to the trailer.

Similarly, a flexible, tubular air line has a free end for connecting the air-generating system contained within the tractor to the trailer or for making connections for the air-generating system from one trailer to another in order to operate the power brakes of the trailer or subsequent trailer. Attached to the free end of the air line is a connector, which, in the art, is termed a “glad hand.”

When the tractor is not connected to the trailer (or a second trailer is not connected to a first trailer), the free end of the electrical line and the attached power plug as well as the free end of the air line and the attached glad hand are either unrestrained (and, therefore, bounce around the rear of the tractor) or are removably attached to unsheltered hooks from which they often become dislodged.

Numerous patents have been granted for devices to hold the glad hands and plugs when they are connected to the hoses and cables but not to the trailer (or a subsequent trailer), but they do not appear to have gained substantial commercial acceptance.

U.S. Pat. No. 2,733,033 covers only a support for a hose. There is no independent structure for glad hands and plugs. Furthermore, there is no container.

The device of U.S. Pat. No. 3,176,257 is simply a bracket; again there is no container.

The Storing Device of U.S. Pat. No. 3,482,203 has a hood into which a single electrical plug is inserted and then retained by a pivoting bail.

The Keeper of U.S. Pat. No. 4,366,965 is merely a holder with no container.

The Electrical Connector Protector of U.S. Pat. No. 4,738,641 has a tubular housing holding a single electrical plug with spring force, a pivoting protection cover, and an open bottom. There is no cover for the bottom when ho plug is inserted, and no means is disclosed for holding the protective cover open.

U.S. Pat. No. 5,607,221 discloses brackets to hold the glad hands and a socket for the plug.

U.S. Pat. No. 5,630,728 applies to an open-topped holder for a single electrical plug.

The Holder of U.S. Pate. No. 5,660,408 does have a container, but the container has an open side, which would substantially expose the glad hands and plugs to the elements. The glad hands and plugs rest above a single slot in the bottom of the open container.

And, finally, the Holder of U.S. Pat. No. 5,988,569 as well as the Bracket of U.S. patent publication no. 2006/0055205 have no cover.

### BRIEF SUMMARY OF THE INVENTION

The Storage Compartment for Truck Tractor Lines of the present invention is, when installed, closed on all sides except for that portion of a shelf necessary to admit and hold the glad hands and power plug. An optional lower cover can close the entire container when no glad hand or power plug is present.

Access is through a rear door which can preferably be placed and remain in either an open or a closed position.

### BRIEF DESCRIPTION OF THE SEVERAL VIEWS OF THE DRAWING

FIG. 1 is a perspective view of an opened Storage Compartment for Truck Tractor Lines containing two glad hands and a power plug.

FIG. 2 is a perspective view of the embodiment of FIG. 1 with the glad hands and the power plug inserted and having the rear door completely closed.

FIG. 3 is a perspective view of the embodiment of FIG. 1 with the rear door and the lower cover completely closed.

FIG. 4 is a plan view from the rear of the embodiment of FIG. 1 having the rear door and the lower cover completely open and showing, in phantom, two glad hands and a power plug inside the container.

FIG. 5 is a plan view from the bottom of the embodiment of FIG. 1 with the rear door and the lower cover both completely open.

FIG. 6 is a lateral view of an opened Storage Compartment for Truck Tractor Lines showing, in phantom, a glad hand inserted in the Compartment and the rear door in a partially closed position.

FIG. 8 is a perspective view of an alternate embodiment for the Storage Compartment for Truck Tractor Lines having a rolling door that is completely closed.

FIG. 9 is a view of the interior of the container for the Storage Compartment taken along the line and in the direction indicated by the arrows 8-8 in FIG. 1.

FIG. 10 is a cutaway view of the first side of the container, showing a first exemplary alternate structure for maintaining the door of the container in an open position.

FIG. 11 is a cutaway view of the second side of the container, illustrating optional structure that supplements the structure of FIG. 10 for maintaining the door of the container in an open position.

FIG. 12 is a cutaway view of the first side of the container, depicting a second exemplary alternate structure for maintaining the door of the container in an open position.

FIG. 13 is a cutaway view of the second side of the container, illustrating optional structure that supplements the structure of FIG. 12 for maintaining the door of the container in an open position.

FIG. 14 is similar to the embodiment of FIG. 1 except that a fourth holding channel is present in the embodiment of FIG. 14.

FIG. 15 portrays the same embodiment as that of FIG. 8 with the rolling door; however, the rolling door extends along the bottom, as well as the rear, of the container.

### DETAILED DESCRIPTION OF THE INVENTION

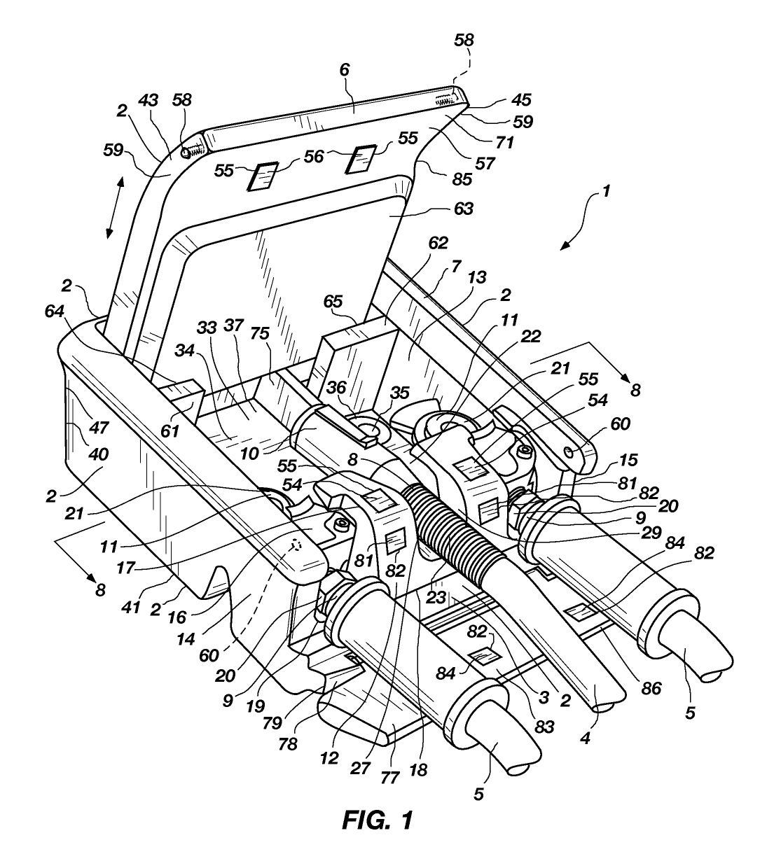

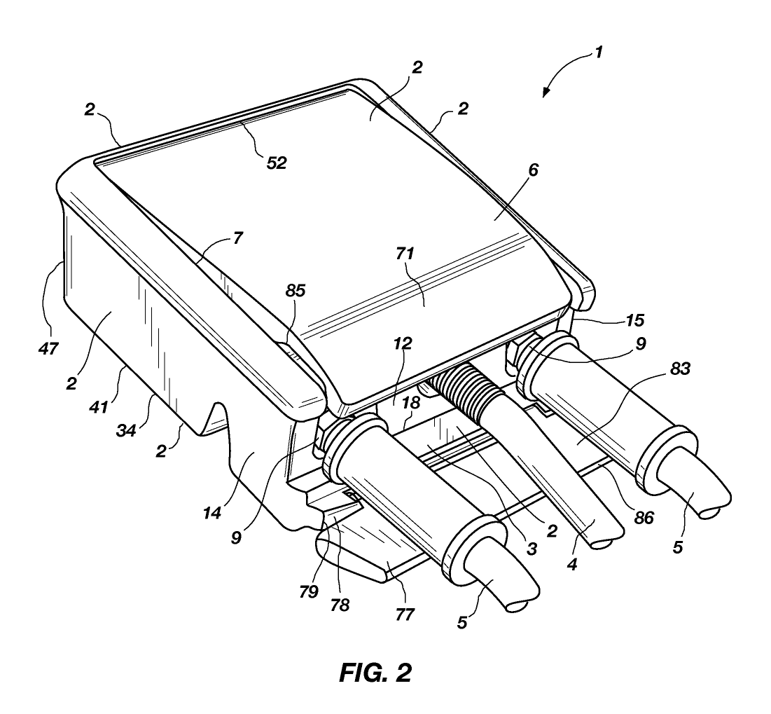

The present Storage Compartment for Truck Tractor Lines is, as shown in FIGS. 1 and 2, a container 1 enclosed, when installed, on every side 2 except the bottom 3, through which the electrical line 4 and the air line 5 enter the container 1.

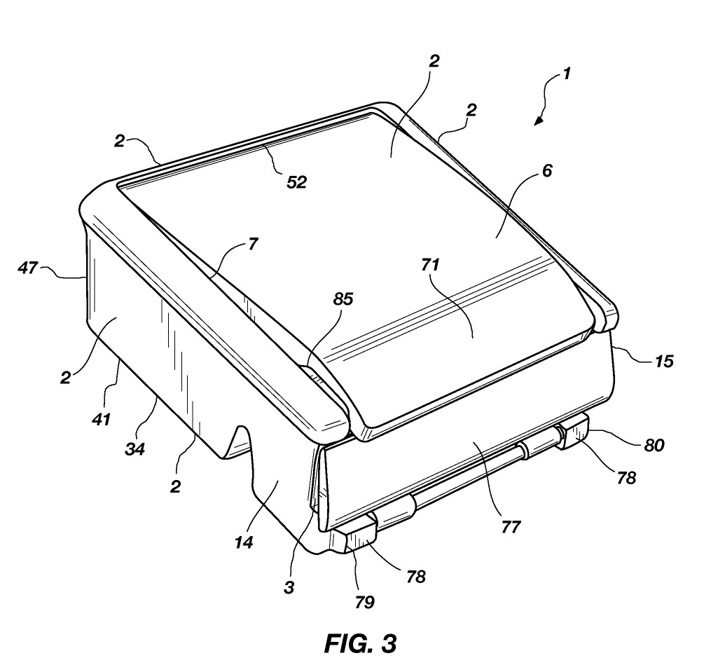

A door 6 is located at the rear 7 of the container 1 and, when closed, as shown in FIGS. 2 and 3, precludes the electrical line 4 and the air line 5 from being dislodged. Furthermore, the container 1, when in use, shields the stored free end 8 of the electrical line 4 and the stored free end 9 of the air line 5 from the elements, minimizing contamination from dirt and the like as well as protecting the power plug 10, which is, as indicated above, traditionally attached to the free end 8 of the electrical line 4, and the glad hand 11, which is, as observed above, traditionally attached to the free end 9 of the air line 5, both from damage and from having ice accumulate in them.

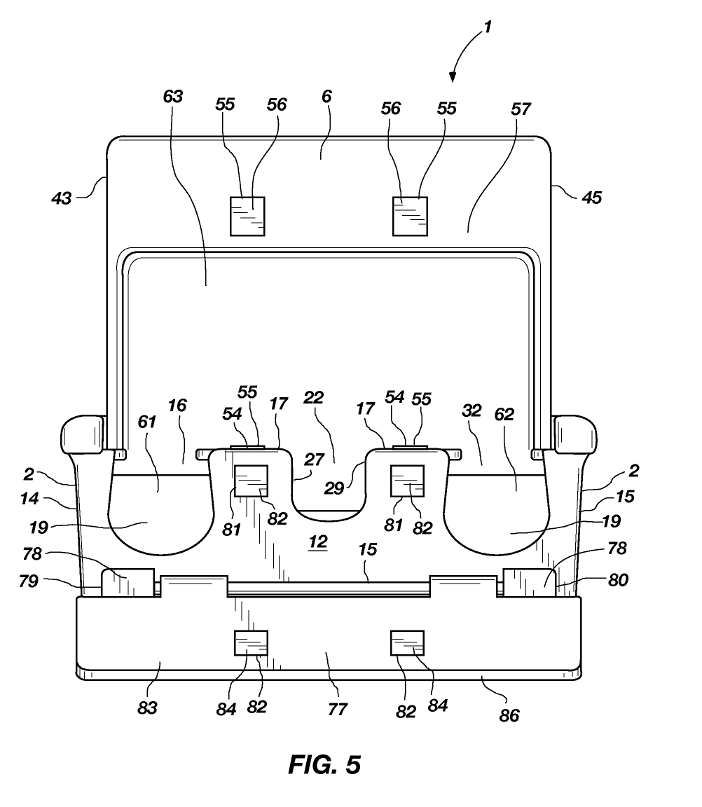

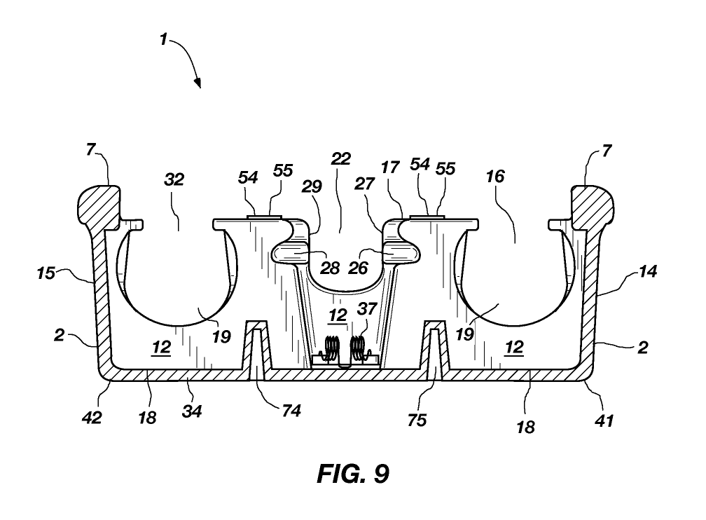

A shelf 12, which is located in the interior 13 of the container 1 above but near the bottom 3 of the container 1 and preferably runs from a closed first side 14 of the container 1 to a closed second side 15 of the container 1, has, as portrayed in FIGS. 1, 2, 4, 5 and 9, a first holding channel 16 opening to the rear 17 of the shelf 12 and running toward the front 18 of the shelf 12 to accommodate placement of a glad hand 11 and free end 9 of an air line 5 within this first holding channel 16. The portion 19 of the first channel 16 near the front 18 of the shelf 12 is wider to accommodate the proximal portion 20 of the glad hand 11 but is also sized and shaped to preclude the more distal and major portion 21 of the glad hand 11 from passing through the first holding channel 16.

Similarly, a second holding channel 22 opens to the rear 17 of the shelf 12 and runs toward the front 18 of the shelf 12 to accommodate placement of a power plug 10 and free end 8 of an electrical line 4 within this second holding channel 22. The second holding channel 22 is sized and shaped to accommodate the proximal portion 23 of the power plug 10 but to preclude the lateral projections 24, 25 on the power plug 10 from passing through the second holding channel 22. Preferably, a first notch 26, on the first side 27 of the second holding channel 22, and a second notch 28, on the second side 29 of the second holding channel 22, accommodate the distal portion 30 of the first lateral projection 24 and the distal portion 31 of the second lateral projection 25 in order to add further stability to the retention of the power plug 10.

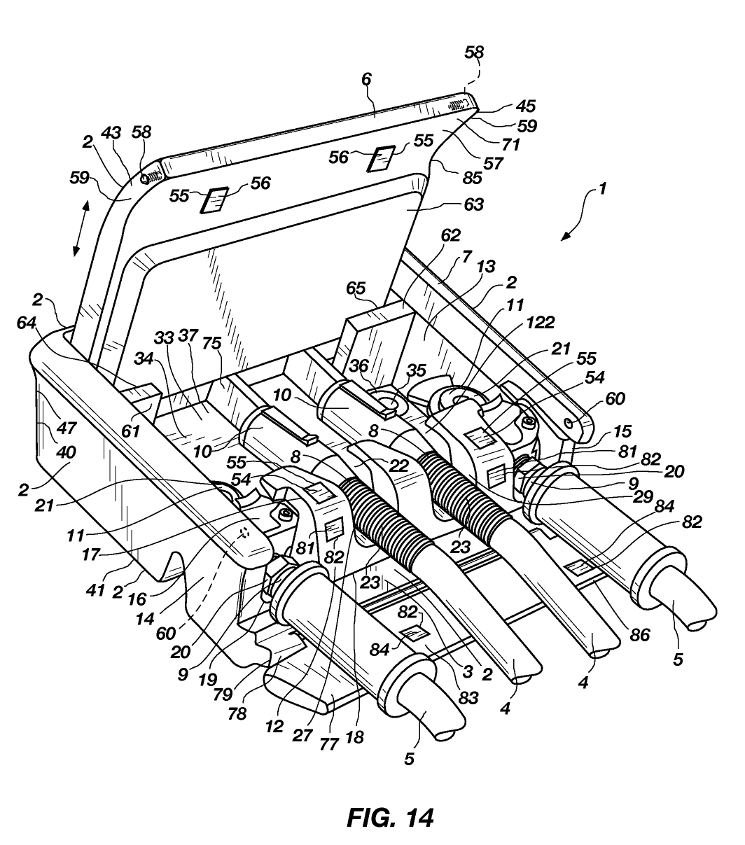

And, also preferably a third holding channel 32 is located in the shelf 12 and is identical to the first holding channel 16 in order to retain an additional glad hand 11. Likewise, as portrayed in FIG. 14, a fourth holding channel 122 is optionally located in the shelf 12 and is identical to the second holding channel 22 in order to retain an additional power plug 10 and free end 8 of an electrical line 4.

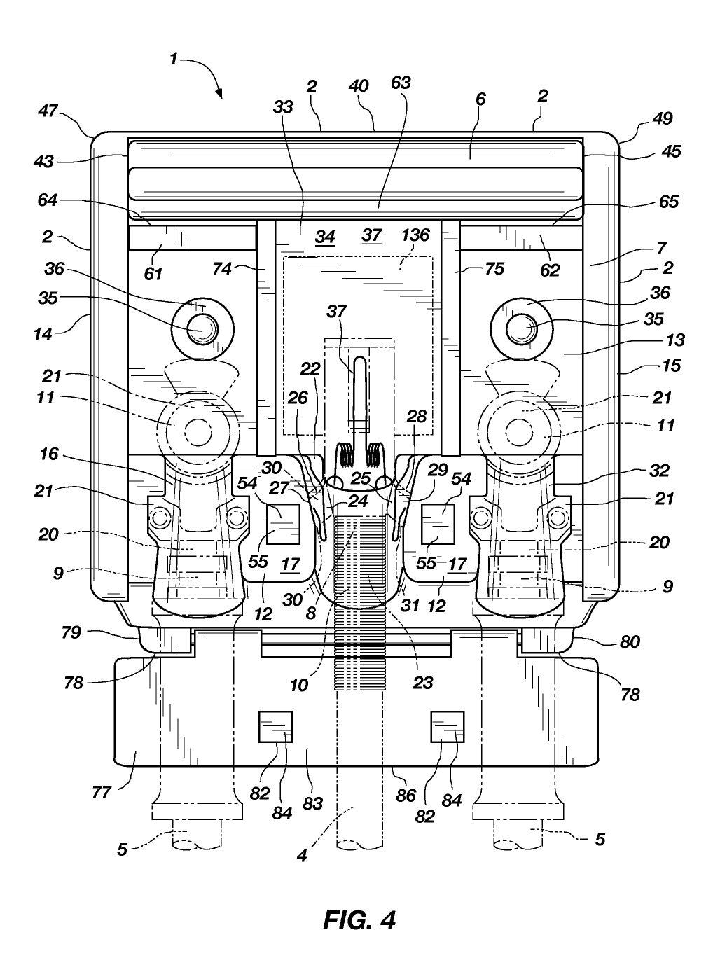

Furthermore, the upper inside 33 of the front 34 of the container 1 preferably has, when the front 34 is closed, as illustrated in FIGS. 1 and 4, at least one projection 35, and, preferably, two projections 35, extending rearward to hold extra rubber grommets 36 for the glad hand 11. Similarly preferably attached to the inside 37 of the front 34 of the container 1, as shown in FIG. 4, is at least one spring 38 for releasably retaining a flashlight, pressure gauge, or other items of use to a truck driver, such as an air line repair kit 136.

The front 34 of the container 1 is weatherproof, which means herein that the front 34 is either (a) closed or (b) adapted for sealing engagement, which means herein, using any technique that is well known in the art, the leading edge 39 of the closed top 40 of the container 1, the leading edge 41 of the first side 14 of the container 1, and the leading edge 42 of the second side 15 of the container 1 are so constructed that any sealant-type material that is well known in the art (such as caulking or a rubber liner) can be utilized in conjunction with the top 40, the first side 14, and the second side 15 of the container 1 to create an attachment of the container 1 to the tractor (or, optionally, to a trailer) that will preclude the passage of moisture. A nonexclusive example of adaptation for sealing engagement is having the leading edge 39 of the top 40, the leading edge 41 of the first side 14, and the leading edge 42 of the second side 15 of the container 1 shaped substantially to conform to the surface of the structure (tractor or trailer) to which they are to be attached; and a nonexclusive examples of a material utilized in conjunction with the top 40, first side 14, and second side 15 of the container 1 to create a weatherproof attachment is traditional caulking or a rubber gasket placed between the leading edges 39, 41, and 42 of the top 40, first side 14, and second side 15 of the container 1 and the surface of the structure (tractor or trailer) to which they are to be attached.

And, further to protect the interior 13 of the container 1 from the weather, the shelf 12 preferably runs from the front 34 of the container 1 to the rear 7 of the container 1.

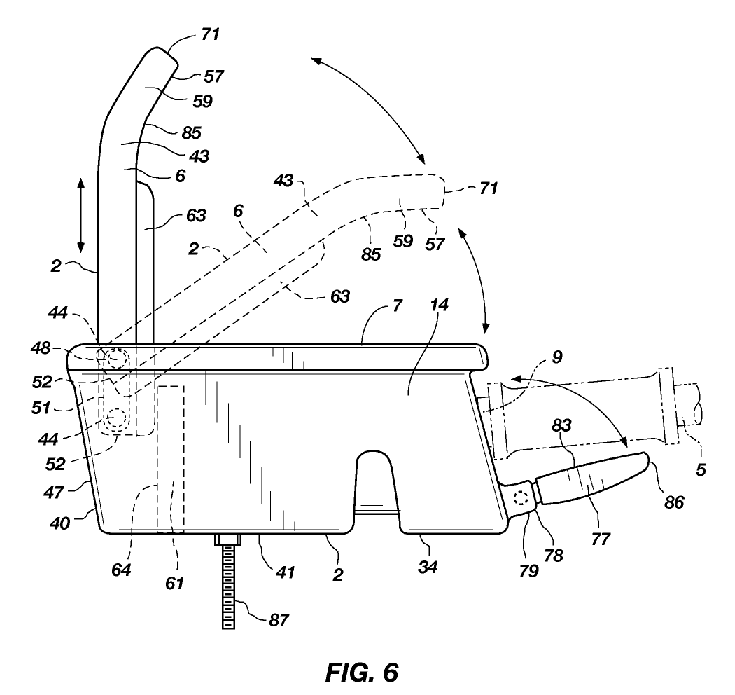

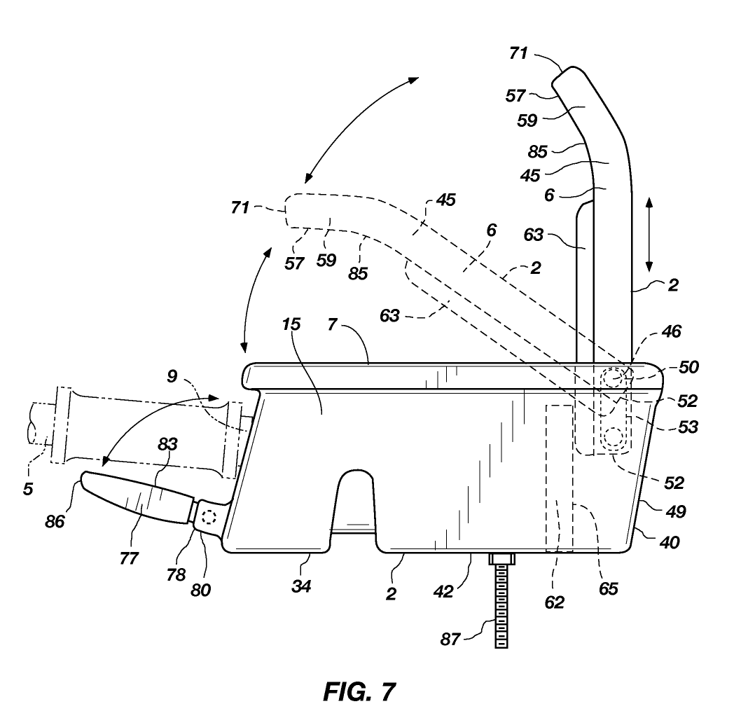

Preferably, as portrayed most clearly in FIGS. 6 and 7, the door 6 can remain in either a fully open or a fully closed position.

A preferred embodiment of the door 6 is illustrated in FIGS. 1, 2, 3, 5, 6 and 7.

On the first side 43 of the door 6 is located a first door projection 44. Similarly, on the second side 45 of the door 6 is located a second door projection 46.

Near the top 47 of the first side 14 of the container 1 there is a first circular channel 48 having a diameter sufficient to permit rotation of the first door projection 44 within such first circular channel 48. Preferably, similarly, near the top 49 of the second side 15 of the container 1 there is a second circular channel 50 having a diameter sufficient to permit rotation of the second door projection 46 within such second circular channel 50.

Extending forward from the first circular channel 48 is a first linear channel 51 having a width sufficient to accommodate the first door projection 44 so that when the upper portion 52 of the door 6 is rotated into a substantially horizontal position, the first door projection 44 slides into the first linear channel 51. Preferably, the first circular channel 48 and the first linear channel 51 constitute a unitary structure. Similarly, extending forward from the second circular channel 50 is a second linear channel 53, which functions with respect to the second door projection 46 just as does the first linear channel 51 with respect to the first door projection 44. And, preferably, the second circular channel 50 and the second linear channel 53 constitute a unitary structure.

Preferably, a first portion 54 of a fastening device 55 is, as illustrated in FIG. 1, attached to the shelf 12 of the container 1; and, also preferably, a mating portion 56 of the fastening device 55 is attached to the inside surface 57 of the door 6 in such a position that the first portion 54 of the fastening device 55 can mate with the mating portion 56 of the fastening device 55 releasably to fasten the door 6 when the door projections 44, 46 have been moved into the circular channels 48, 50 and the door 6 has then been rotated downward and completely closed. Most preferably, the fastening device 55 comprises either magnets or hook and loop fasteners such as those sold under the trademarked name VELCRO, although any type of fastening device 55 that is well known in the art is acceptable, such as the spring-mounted ball 58 shown in the edges 59 of the door 6 with corresponding depressions 60 in the first side 14 and the second side 15 of the container 1. There can be more than one fastening device 55; and, in fact, there are preferably two fastening devices 55. And the fastening device 55 can, if desired, be a traditional lock.

And, also preferably, extending inward from the first side 14 of the container 1 is a first auxiliary support structure 61 for the door 6 when the door 6 is in a completely open position; and preferably extending inward from the second side 15 of the container 1 is a second auxiliary support structure 62 for the door 6 when the door 6 is in a completely open position. Furthermore, preferably, the inside surface 57 of the door 6 extends forward to create an extended portion 63 of the door 6 such that, when the door 6 is completely closed, the extended portion 63 of the door 6 is above the shelf 12 and below the linear channels 51, 53 as well as below the auxiliary support structures 61, 62 when such auxiliary support structures 61, 62 are present. Additionally preferably, the inside surface 57 of the door 6, when the door 6 is completely open, is near the top 64 of the first auxiliary support structure 61 and the top 65 of the second auxiliary support structure 62 when there is no extended portion of the door; but, when there is an extended portion 63 of the door 6, such extended portion 63 is near the top 64 of the first auxiliary support structure 61 and the top 65 of the second auxiliary support structure 62. Such extended portion 63 tends to facilitate the even more secure retention of any power plug 10 or glad hand 11 that is in the container 1 when the door 6 is closed by preferably being near the auxiliary support structures 61, 62.

Preferably, the auxiliary support structures 61, 62 reach the front 34 of the container 1 when the front 34 is closed.

The auxiliary support structures 61, 62 also maintain the door 6 in an open position by precluding the rotation of such door 6. Of course, only one of the auxiliary support structures 61, 62 is necessary for this purpose, although it is preferred to have both auxiliary support structures 61, 62.

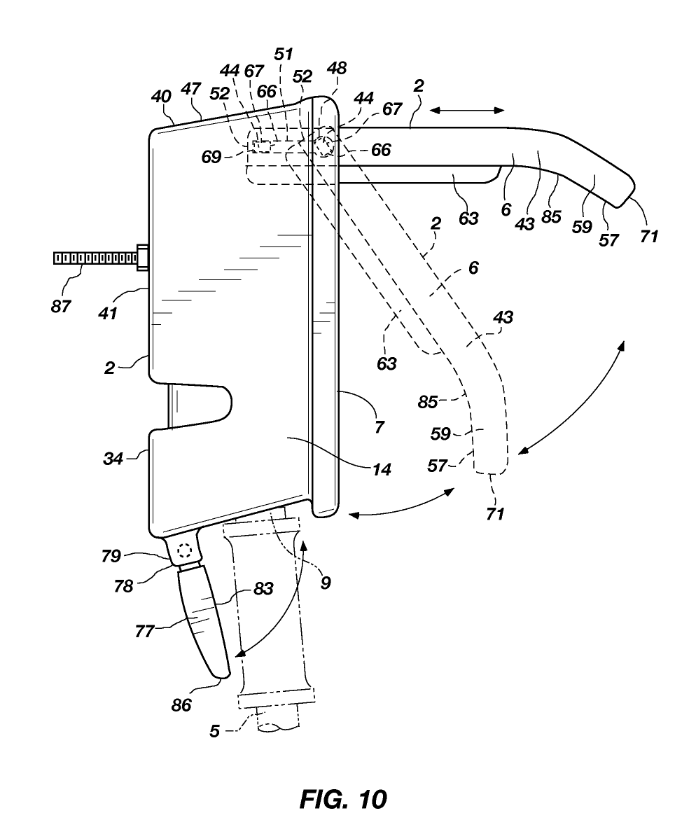

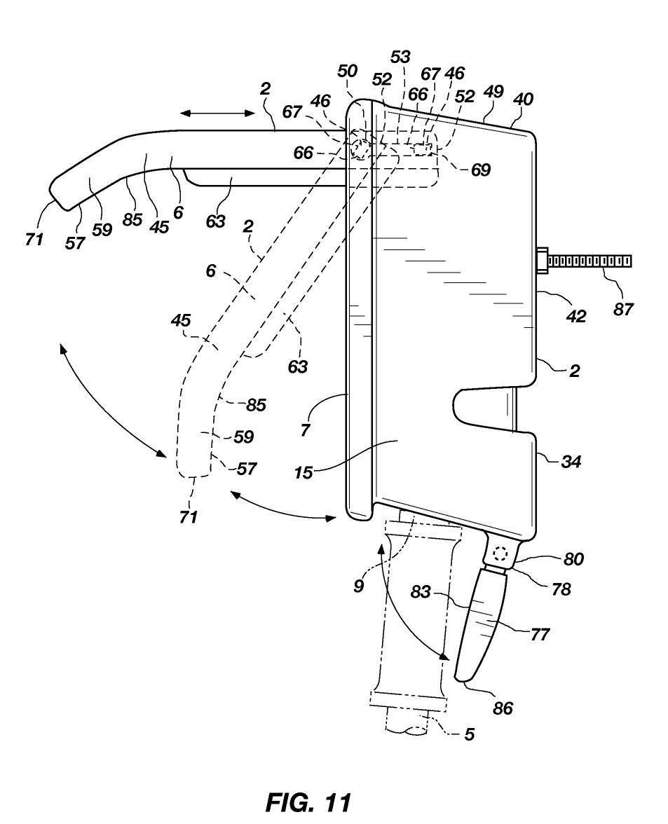

One skilled in the art will envision a variety of alternate structures for maintaining the door 6 in an open position. A first example would be, as illustrated in FIG. 10, having the first door projection 44 elongated with a width 66 sufficient to be accommodated by the first linear channel 51 but a length 67 which exceeds the thickness 68 of the first linear channel 51 but which length 67 is less than the diameter 69 of the first circular channel 48. Preferably, as portrayed in FIG. 11, the second door projection 46, the second linear channel 53, and the second circular channel 50 will have similar relative dimensions. In this option, contrary to the other related options discussed herein, the thickness 68 of the linear channels 51, 53 must be less than the diameter 69 of the circular channels 48, 50.

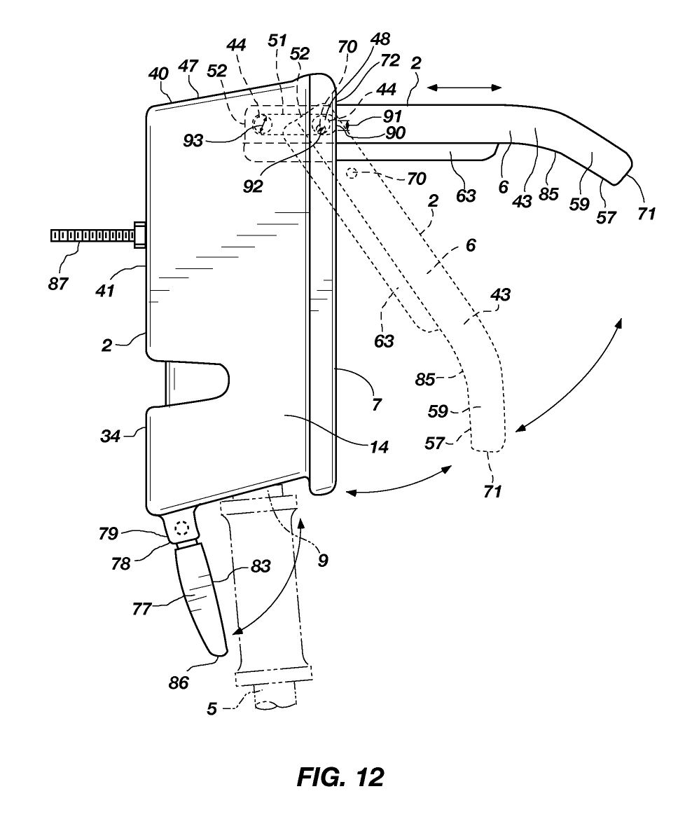

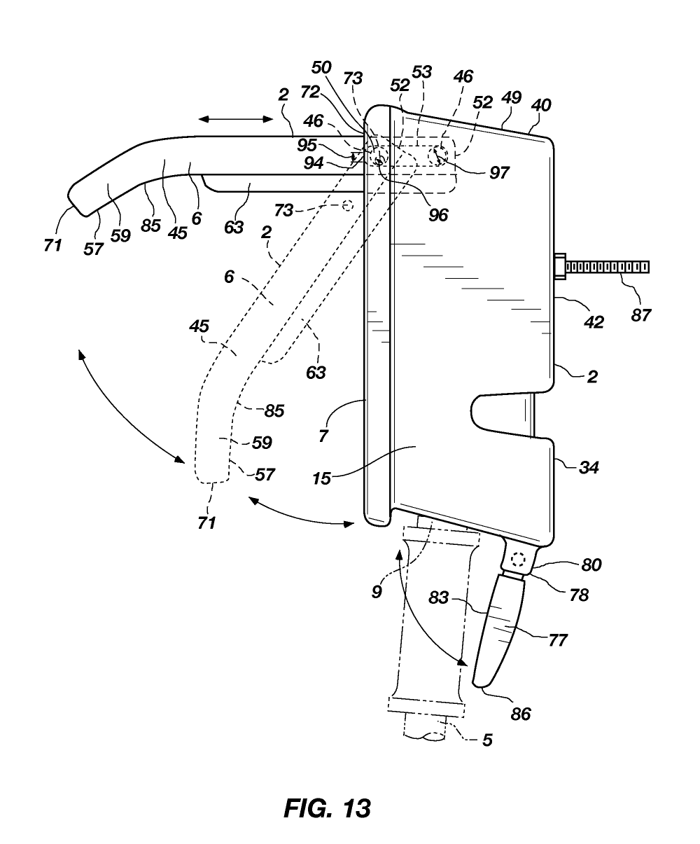

A second example would be, as demonstrated in FIG. 12, having a supplemental first door projection 70 on the first side 43 of the door 6 closer to the lower end 71 of the door 6 than is the first door projection 44. With this option the first circular channel 48 must extend to the rear face 72 of the container 1, where an aperture 90 exists in order to permit the supplemental first door projection 70 to enter and exit the first circular channel 48 and the first linear channel 51. The diameter 91 of the aperture 90 is preferably selected to be larger than the diameter 92 of the supplemental first door projection 70 but smaller than the diameter 93 of the first door projection 44 in order to permit the desired passage of the supplemental first door projection 70 but to preclude passage by the first door projection 44. Preferably, as shown in FIG. 13, there is also a supplemental second door projection 73 on the second side 45 of the door 6 closer to the lower end 71 of the door 6 than is the second door projection 46; and, again, in order to permit the supplemental second door projection 73 to enter and exit the second circular channel 50 and the second linear channel 53, the second circular channel 50 must extend to the rear face 72 of the container 1, where an aperture 94 exists in order to permit the supplemental second door projection 73 to enter and exit the second circular channel 50 and the second linear channel 53. The diameter 95 of the aperture 94 is preferably selected to be larger than the diameter 96 of the supplemental second door projection 73 but smaller than the diameter 97 of the second door projection 46 in order to permit the desired passage of the supplemental second door projection 73 but to preclude passage by the second door projection 46. Furthermore, in order to keep the door 6 substantially level when it is open, the supplemental first door projection 70, having a smaller diameter 92 than the diameter 93 than the first door projection 44, is preferably located closer to the inside surface 57 of the door 6 than is the first door projection 44. Similarly, the supplemental second door projection 73, having a smaller diameter 96 than the diameter 97 of the second door projection 46, is preferably located closer to the inside surface 57 of the door 6 than is the second door projection 46.

And finally, preferably with this preferred embodiment of the door, a first support stop 74 and a second support stop 75, when the extended portion 63 of the door 6 is present, both form a stop for the extended portion 63 and provide supplemental support for the door 6 by being near the inside surface 57 of the door 6 when the door 6 is completely open, although either support stop 74, 75, would be adequate by itself.

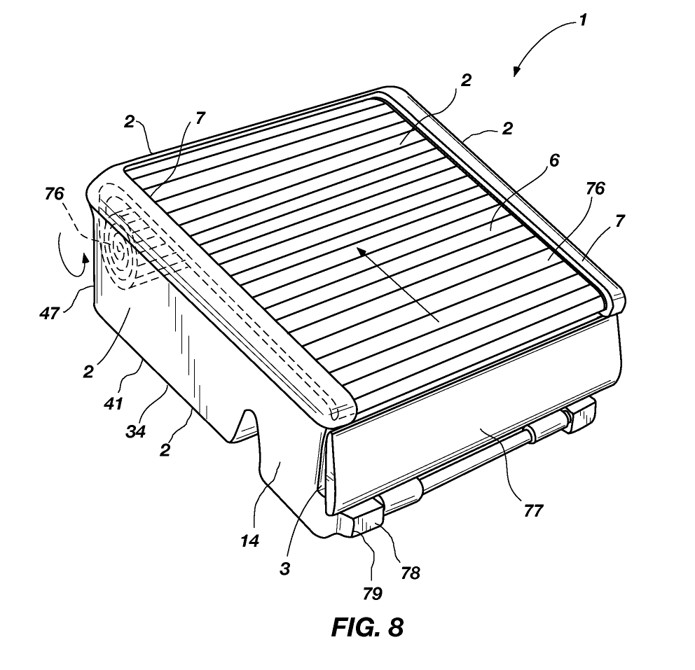

Another satisfactory, but nonexclusive, example of structure permitting the door 6 to remain in either a fully open or a fully closed position is the rolling door 76 shown in FIG. 8, which would remain open from the friction that is inherent in a rolling door 76.

Preferably, a lower cover 77 is attached, as portrayed in FIGS. 1 through 7, to the bottom 3 of the container 1 in order to cooperate with the door 6 and completely close the container 1 when no power plug 10 or glad hand 11 is within the container 1.

Also preferably, the lower cover 77 is pivotally attached to the front 34 of the container 1 at the bottom 78 of such front 34 (when the front 34 is closed) or to the bottom 79 of the first side 14 of the container 1 and to the bottom 80 of the second side 15 of the container 1 (when the front 34 is adapted for sealing engagement).

One method of releasably maintaining the lower cover 77 closed is attaching to the shelf 12 a first portion 81 of a cover fastening device 82 and attaching to the inside surface 83 of the lower cover 77 a mating portion 84 of the cover fastening device 82 in such a position that the first portion 81 of the cover fastening device 82 can mate with the mating portion 84 of the cover fastening device 82 when the lower cover 77 has been completely closed, in the same manner as described above for releasably maintaining the door 6 closed. When this method is utilized, most preferably the cover fastening device 82 comprises either magnets or hook and loop fasteners such as those sold under the trademarked name VELCRO. There can be more than one cover fastening device 82; and, in fact, when used, there are preferably two cover fastening devices 82. And the cover fastening device 82 could, if desired, be a traditional lock.

The preferred method of releasably maintaining the lower cover 77 closed is, however, having a concave curve 85 on the lower end 71 of the door 6 while also having the door 6 and the lower cover 77 of such size and shape that, when the lower cover 77 has been closed first and the door 6 is then closed, the lower end 71 of the door 6 will curve around the free end 86 of the lower cover 77. Consequently, when the door 6 is held releasably closed as described above, the door 6 will hold the lower cover 77 releasably closed, as illustrated in FIG. 3.

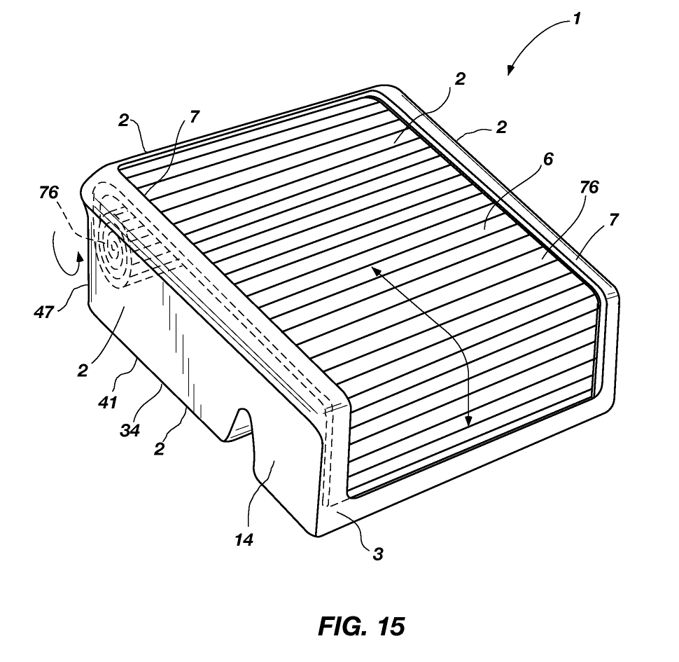

When the rolling door 76 is utilized, however, the rolling door 76 can optionally, as illustrated in FIG. 15, extend across the bottom 3 of the container 1 as well as the rear 7 of the container 1, thereby eliminating the need for the lower cover 77.

Any apparatus that is well known in the art, preferably bolts 87, can be utilized to connect or mount the container 1 to a tractor or to a trailer for storing the free ends of one or more electrical lines 4 and air lines 5 which can run from that trailer to another trailer. The lateral view of FIG. 6 and the lateral view of FIG. 7 show a bolt 87 attached to the front 34 of the container 1 for this purpose. Such bolts 87 are generally used in pairs; the bolt 87 pictured in FIGS. 6 and 7 obscures the other bolt 87 of the pair, although one such bolt 87 is shown in FIG. 6 while the other such bolt 87 is illustrated in FIG. 7.

As used herein, the term “substantially” indicates that one skilled in the art would consider the value modified by such terms to be within acceptable limits for the stated value. Also as used herein, the term “preferable” or “preferably” means that a specified element or technique is more acceptable than another but not that such specified element or technique is a necessity.

I claim:

1. A storage compartment for truck tractor lines, which comprises:
a closed top having a leading edge;
a bottom;
a weatherproof front having a bottom;
a closed first side having a leading edge;
a closed second side having a leading edge;
a rear door having a lower end and an inside surface; and
a shelf running from said closed first side to said closed second side and from said weatherproof front to said rear door, said shelf having at least one holding channel to accommodate a glad hand and a free end of an air line attached to the glad hand and also having at least one holding channel to accommodate a power plug and a free end of an electrical line attached to the power plug.

2. The storage compartment for truck tractor lines as recited in claim 1, wherein:
said weatherproof front is closed.

3. The storage compartment for truck tractor lines as recited in claim 2, wherein said rear door is pivotally attached to said closed first side and is also pivotally attached to said closed second side.

4. The storage compartment for truck tractor lines as recited in claim 3, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

5. The storage compartment for truck tractor lines as recited in claim 3, further comprising:
a lower cover pivotally attached to the bottom of said weatherproof front, said lower cover having a free end; and
wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

6. The storage compartment for truck tractor lines as recited in claim 3, further comprising:
a means for maintaining said rear door in an open position.

7. The storage compartment for truck tractor lines as recited in claim 6, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

8. The storage compartment for truck tractor lines as recited in claim 6, further comprising:
a lower cover pivotally attached to the bottom of said weatherproof front, said lower cover having a free end; and
wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

9. The storage compartment for truck tractor lines as recited in claim 3, further comprising:
a fastening device, which comprises:
a first portion attached to said shelf; and
a mating portion of said fastening device attached to the inside surface of said rear door in such a position that the first portion of said fastening device can mate with the mating portion of said fastening device.

10. The storage compartment for truck tractor lines as recited in claim 9, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

11. The storage compartment for truck tractor lines as recited in claim 9, further comprising:
a lower cover pivotally attached to the bottom of said weatherproof front, said lower cover having a free end; and
wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

12. The storage compartment for truck tractor lines as recited in claim 9, further comprising:
a means for maintaining said rear door in an open position.

13. The storage compartment for truck tractor lines as recited in claim 12, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

14. The storage compartment for truck tractor lines as recited in claim 12, further comprising:
a lower cover pivotally attached to the bottom of said weatherproof front, said lower cover having a free end; and
wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

15. The storage compartment for truck tractor lines as recited in claim 2, wherein:
said rear door is a rolling door.

16. The storage compartment for truck tractor lines as recited in claim 15, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

17. The storage compartment for truck tractor lines as recited in claim 15, wherein:
the rolling door, in addition to comprising said rear door, extends across said bottom of the storage compartment.

18. The storage compartment for truck tractor lines as recited in claim 2, further comprising:
a means for maintaining said rear door in an open position.

19. The storage compartment for truck tractor lines as recited in claim 18, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

20. The storage compartment for truck tractor lines as recited in claim 18, further comprising:
a lower cover pivotally attached to the bottom of said weatherproof front, said lower cover having a free end; and
wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

21. The storage compartment for truck tractor lines as recited in claim 2, further comprising:
a lower cover pivotally attached to the bottom of said weatherproof front, said lower cover having a free end; and
a cover fastening device, which comprises:
a first portion attached to said shelf; and
a mating portion of said cover fastening device attached to the inside surface of said lower cover in such a position that the first portion of said cover fastening device can mate with the mating portion of said cover fastening device.

22. The storage compartment for truck tractor lines as recited in claim 2, further comprising:
a lower cover pivotally attached to the bottom of said weatherproof front, said lower cover having a free end; and
wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

23. The storage compartment for truck tractor lines as recited in claim 1, wherein:
said weatherproof front is adapted for sealing engagement.

24. The storage compartment for truck tractor lines as recited in claim 23, wherein
said rear door is pivotally attached to said closed first side and is also pivotally attached to said closed second side.

25. The storage compartment for truck tractor lines as recited in claim 24, further comprising:
a lower cover pivotally attached to the bottom of said weatherproof front, said lower cover having a free end.

26. The storage compartment for truck tractor lines as recited in claim 25, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

27. The storage compartment for truck tractor lines as recited in claim 24, further comprising:
a means for maintaining said rear door in an open position.

28. The storage compartment for truck tractor lines as recited in claim 27, further comprising:
a lower cover pivotally attached to the bottom of said weatherproof front, said lower cover having a free end.

29. The storage compartment for truck tractor lines as recited in claim 28, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

30. The storage compartment for truck tractor lines as recited in claim 24, further comprising:
a fastening device, which comprises:
a first portion attached to said shelf; and
a mating portion of said fastening device attached to the inside surface of said rear door in such a position that the first portion of said fastening device can mate with the mating portion of said fastening device.

31. The storage compartment for truck tractor lines as recited in claim 30, further comprising:
a lower cover pivotally attached to the bottom of said weatherproof front, said lower cover having a free end.

32. The storage compartment for truck tractor lines as recited in claim 31, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

33. The storage compartment for truck tractor lines as recited in claim 30, further comprising:
a means for maintaining said rear door in an open position.

34. The storage compartment for truck tractor lines as recited in claim 33, further comprising:
a lower cover pivotally attached to the bottom of said weatherproof front, said lower cover having a free end.

35. The storage compartment for truck tractor lines as recited in claim 34, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

36. The storage compartment for truck tractor lines as recited in claim 23, wherein:
said rear door is a rolling door.

37. The storage compartment for truck tractor lines as recited in claim 36, further comprising:
a lower cover pivotally attached to the bottom of said weatherproof front, said lower cover having a free end.

38. The storage compartment for truck tractor lines as recited in claim 37, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

39. The storage compartment for truck tractor lines as recited in claim 23, further comprising:
a means for maintaining said rear door in an open position.

40. The storage compartment for truck tractor lines as recited in claim 39, further comprising:
a lower cover pivotally attached to the bottom of said weatherproof front, said lower cover having a free end.

41. The storage compartment for truck tractor lines as recited in claim 40, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

42. The storage compartment for truck tractor lines as recited in claim 23, further comprising:
a lower cover pivotally attached to the bottom of said weatherproof front, said lower cover having a free end.

43. The storage compartment for truck tractor lines as recited in claim 42, wherein:
said rear door has a concave curve on the lower end of said rear door; and
said rear door and said lower cover are of such size and shape that, when said lower cover has been closed first and said rear door has been subsequently closed, the lower end of said rear door curves around the free end of said lower cover.

44. A storage compartment for truck tractor lines, which comprises:
a closed top having a leading edge;
a closed front having a bottom;
a closed first side having a leading edge;
a closed second side having a leading edge;
a rear door having a lower end and an inside surface, said rear door being pivotally attached to said closed first side and also being pivotally attached to said closed second side, and said rear door also having a concave curve on the lower end of said rear door;
a shelf running from said closed first side to said closed second side and from said weather proof front to said rear door, said shelf having at least one holding channel to accommodate a glad hand and a free end of an air line attached to the glad hand and also having at least one holding channel to accommodate a power plug and a free end of an electrical line attached to the power plug;
a fastening device, which comprises:
a first portion attached to said shelf; and
a mating portion of said fastening device attached to the inside surface of said rear door in such a position that the first portion of said fastening device can mate with the mating portion of said fastening device;
a means for maintaining said rear door in an open position;
a lower cover pivotally attached to the bottom of said weatherproof front, said lower cover having a free end, wherein said rear door and said lower cover are of such size and shape that, when said lower cover has been closed first and said rear door has been subsequently closed, the lower end of said rear door curves around the free end of said lower cover; and
a means for mounting said closed front.

45. A storage compartment for truck tractor lines, which comprises:
a closed top having a leading edge;
a front adapted for sealing engagement and having a bottom;
a closed first side having a leading edge;
a closed second side having a leading edge;
a rear door having a lower end and an inside surface, said rear door being pivotally attached to said closed first side and also being pivotally attached to said closed second side, and said rear door also having a concave curve on the lower end of said rear door;
a shelf running from said closed first side to said closed second side and from said weather proof front to said rear door, said shelf having at least one holding channel to accommodate a glad hand and a free end of an air line attached to the glad hand and also having at least one holding channel to accommodate a power plug and a free end of an electrical line attached to the power plug;
a fastening device, which comprises:
a first portion attached to said shelf; and
a mating portion of said fastening device attached to the inside surface of said rear door in such a position that the first portion of said fastening device can mate with the mating portion of said fastening device;
a means for maintaining said rear door in an open position;
a lower cover pivotally attached to the bottom of said weatherproof front, said lower cover having a free end, wherein said rear door and said lower cover are of such size and shape that, when said lower cover has been closed first and said rear door has been subsequently closed, the lower end of said rear door curves around the free end of said lower cover; and
a means for mounting said closed first side and said closed second side.
